(19) United States
(12) Patent Application Publication
(10) Pub. No.: US 2005/0180704 A1
(43) Pub. Date: Aug. 18, 2005

(54) Open type tape for buffer tube and other uses

(76) Inventors: Simon J. Terry, Renfrew (CA); Cameron Gallamore, Charlotte, NC (US)

Correspondence Address: CESARI AND MCKENNA, LLP, 88 BLACK FALCON AVENUE, BOSTON, MA, 02210, US

(21) Appl. No.: 11/057,354

(22) Filed: Feb. 14, 2005

Related U.S. Application Data
(60) Provisional application No. 60/545,050, filed on Feb. 17, 2004.

(51) Int. Cl. G02B 6/44

(52) U.S. Cl. 385/100

(57) ABSTRACT

The tape for protecting and mechanically supporting an optical, power, or other such cable is disclosed. An open cell foam layer is coated or layered with a super absorbent layer that is attached to one side of a support layer. In this arrangement, when exposed to water the super absorbent layer expands or swells into the open cell layer. The inner core of the cable is surrounded by the tape with the side of the open cell layer distal from the super absorbent layer facing the inner core. The support layer may have the protective open cell and super absorbent combination attached to both sides of the support layer.

### CROSS-REFERENCE TO RELATED APPLICATIONS

The present application claims the benefit of U.S. Provisional Patent Application Ser. No. 60/545,050, that was filed on Feb. 17, 2004, of common ownership, inventorship and title and which is hereby incorporated herein by reference.

### BACKGROUND OF THE INVENTION

1. Field of the Invention

The present invention is related to tapes used in the manufacture of optical, power and other such cables, and in particular tapes that provide a protective and mechanical support layer together with a water blocking capability. In addition the tapes may be formed as electrically semi-conductive or as a dielectric insulator.

2. Background Information

Tapes are known in the art for wrapping power and signal carrying cables to provide mechanical support and water resistance. Some of these tapes incorporate a super absorbent polymer (SAP) layer that swells when contacting water to prevent water from damaging the cable. Some of these tapes also incorporate a foam layer to provide a mechanical buffer.

One problem of these known tapes relates to their use in fiber optic cable where the tape is in direct contact with the optical fibers. In optical cables, the inner cable core is filled with grease or a gel to protect the optical fibers. Such cables are heavy and difficult to splice and terminate partially due to the difficulty in handling, cleaning and replacing the grease and gel. A lighter cable that is more easily handled would be advantageous.

Attempts to use the prior art tapes have been unsuccessful as the rough surfaces of the SAP on these tapes can touch the optical fibers resulting in micro-bending of the optical fibers resulting in signal loss and/or fiber damage.

Other prior art tapes have included an open foam layer to the SAP layer mentioned above. The foam layer provides a smooth mechanical buffer surface against the inner cable to relieve the problem of the rough SAP particles. The structure of these tapes, however, will not accept the swelling SAP particles. The tape swells upon contact with water with the intent to impede or prevent water from further infiltrating and damaging the inner core of the cable. But, in these prior art tapes, the swelling occurs away from the foam layer and water may still pass through the open foam into and along the inner core.

FIGS. 1A and 1B shows such a prior art tape before and after exposure to water. FIG. 1A shows a tape 2 with a super absorbent polymer (SAP) layer 4, a film or textile support layer 8 and a foam layer 6 positioned on the opposite side of the support layer 8. When exposed to water, the SAP layer expands as shown in FIG. 1B, item 4.’

The present invention is directed to these prior art problems and, inter alia, supplies additional benefits.

### SUMMARY OF THE INVENTION

In view of the foregoing background discussion, the present invention provides a tape and a process for making a tape, where the tape is arranged for protecting and mechanically supporting a cable. The cable may be carry power or information encoded optically and carried on optical fibers or other such cables.

An open cell foam layer is formed and a layer or coating of supper absorbent material is formed on the open cell layer forming a composite tape. The absorbent material is preferably a fiber, powder or liquid. The fiber and powers may be applied using an adhesive. The composite tape thus formed is arranged so that when the super absorbent material swells, usually when exposed to water, the super absorbent material swells by 20 times or more, but the swelling penetrates into the open cell structure.

The composite tape may be attached, usually by pressure, to a support layer typically made from a textile. A composite tape may be attached to both sides of the support tape.

Optical and power cables have inner cores that are surrounded by the inventive tapes. The inner core is facing the open cell layer on the side without the super absorbent material. The inventive tape may be applied in a wound or longitudinal layered fashion.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIGS. 1A and 1B are diagrams of prior art tapes;

FIG. 2 is a cross section view of an unsupported open layer foam impregnated with SAP;

FIG. 3 is a cross section view of the tape of FIG. 2 with a layer of SAP attached to a flim or textile support;

FIG. 4 is a cross section of the tape of FIG. 3 with a SAP and open foam attached to both sides of the support;

FIG. 5 is a diagram of a an apparatus and process for producing a preferred embodiment of the present inventive tape;

FIG. 6 is another diagram of an apparatus and process of producing another preferred embodiment of the inventive tape,

FIG. 7 is another apparatus and process for producing the inventive tape;

FIG. 8 is a diagram of a cable with a wrapped inventive tape;

FIG. 9 is a diagram of another cable with a longitudinally applied inventive tape;

FIG. 10 is a cross section of a prior art optical fiber cable;

FIG. 11 is a cross section of an inventive cable improvement similar to the cable in FIG. 10; and

FIG. 12 is a cross section of a power cable incorporating the present invention.

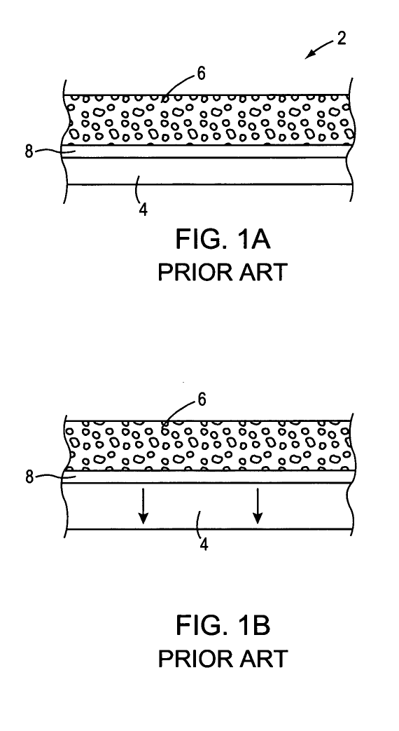

### DETAILED DESCRIPTION OF AN ILLUSTRATIVE EMBODIMENT

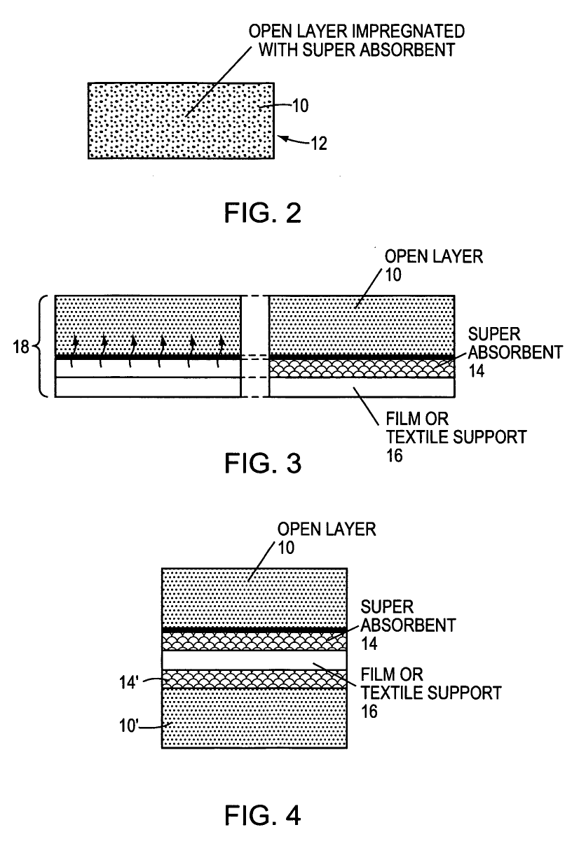

FIG. 2 shows an exemplary view of an open construction layer 10 in combination with an SAP material impregnated 12 within the open layer. In such a construction when exposed to water the SAP layer is arranged to swell within the interstices of the open construction layer. Typically the open construction layer will be an open celled foam layer. Hereafter the term “open layer” will refer to any such layer into which the SAP material may, at least partly, swell. With respect to FIG. 2 SAP material swells into, and in some applications completely saturates the open layer. In typical applications the open layer presents a smooth surface that shields the inner cable core elements (the power or information carrying elements within the cable) from the rough SAP particles. Moreover, the open layer is conformable to the inner cable core elements when applied, thereby holding and securing those elements in position.

The dynamics of the swelling of the SAP substantially into the open layer is controlled by controlling the type and amount of SAP material and the open cell material itself. The result is a controlled increase in the thickness of the tape. Typically thickness increases of 1 to 30 mm are encountered, but such increases are not meant as limiting to the applications or the present invention.

FIG. 3A shows the open layer 10 after an SAP layer 14 is laid onto the open layer and, is shown, with a film of textile layer laid onto the SAP layer. But, the SAP layer extends into the open layer due to the “open” nature of the layer, and most importantly the SAP layer will swell when exposed to water into this open layer, again due to the open nature of the layer, see FIG. 3B. The total thickness of the composite layer 18 will change only marginally when the SAP layer swells after contacting water.

FIG. 4 shows the tape of FIG. 3A with a set of corresponding layers, SAP 14′ and open layer 10′ constructed on the opposite side of the support layer 16. As before the SAP layer swells into the open layers.

The open layer may be of an assortment of materials. Some examples are open cell type (reticulated) synthetic foam comprised of: polyester or polyurethane, polyvinyl chloride (PVC) or polyester (PE). The foam densities often run from about 1 to about 6 pounds per cubic foot, but in some applications higher or lower amounts may be advantageously used. Cell structures of 50 to 500 pores per inch are typical, but higher or lower values may be useful. The thickness of the open layer is typically 0.1 to 6 mm, but again other thickness may be found.

The open layer may also be formed from a textile base, such as carded non-woven, needle punch non-woven or from a synthetic fiber base. In addition combinations of open cell and textile base open materials may be used in an open layer.

The SAP is generally a material that can swell at least 20 times its own volume when exposed to water. Materials include powders, fibers, liquids and combinations thereof. Some examples of powders include: Poly (sodium acrylate) homopolymer or sodium salt of polyacrylic acid; acyclamide potassium acrylate copolymer; cross linked or polyacylate/polyalcohol copolymer; copolymers of maleic anhydride and isobutylene, and others. Powder particles sizes range from about 5 microns to about 1000 microns, with 200 microns most often used.

Some examples of fibers include: cross linked acrylate copolymner, partially neutralized to the sodium salt (in fiber form); and coploymers of maleic anhydride and isobutylene fibers. Fiber in the one to five denier range (very fine) in 1 to 50 mm staple lengths are preferred, and fiber may be reduced to powder form.

Some examples of liquid (for direct impregnation of the open layer) include: self cross linking polyacrylate (liquid), acrylic acid with cross linking agent added at time of use. The liquid when dried or cured becomes solid.

The preceding are but a few SAP agents many others are known and are being developed.

The support layer can be synthetic film, fabric (woven or non-woven), cellulose (paper) scrim, etc. and combinations thereof.

Examples of a synthetic film support layer include: polyester (bi-axially oriented, preferred) polyamide polyamine, and polyethylene. Film thicknesses of 10 to 150 microns are typical, but not limiting.

Examples of fabric include any synthetic material such as polyester or polypropylene non-woven fabric The materials may be carded/resin bonded or spun bonded or melt blown. Woven fabric may also be used.

Cellulose includes paper, airlaid and tissue.

Scrim reinforcement includes: laid scrim, weft inserted scrim, warp beam types. Very open woven fabric may also be sued.

Finished tapes are typically insulating dielectrics, but tapes can be rendered semi-conductive by incorporating carbon black or conductive metal powder, fiber or metallized layers.

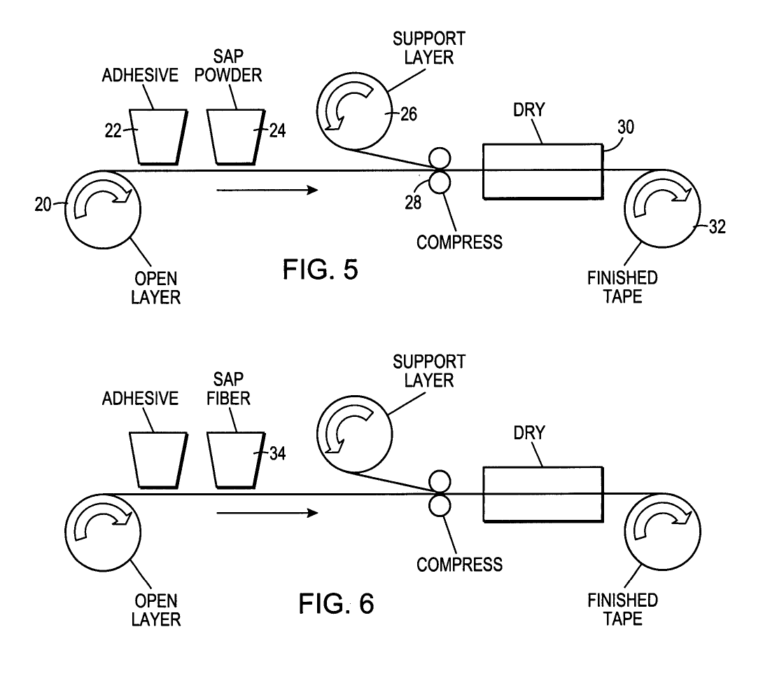

FIG. 5 illustrates constructing a tape with an SAP powder. The open layer 20 is unwound and coated with a wet adhesive 22, then an SAP powder is sprinkled 24 on the adhesive. The adhesive is activated by heat, light or light pressure and combined with a support layer 26 under light pressure. The sandwiched layers are dried 30 and collected on a roll 32.

A dry adhesive may be used and appropriately activated as known in the art. Some preferred examples include: water based acrylic latices (acrylic latex) and polyvinyl alcohol or blends thereof. Other adhesives that may be useful include: thermoplastic polymers such as PE or EVA (hot melt), and, in some applications, polyurethane.

FIG. 6 shows use of an SAP fiber 34 in place of the powder 24. The same processes occur except that the fiber may be flocked onto the wet or dry adhesive.

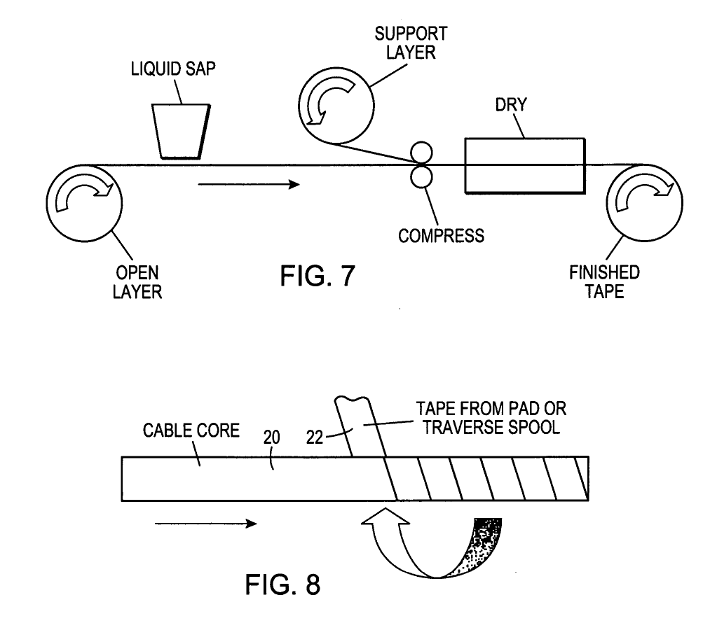

FIG. 7 shows use of a liquid SAP material. Here the SAP material may sprayed, screen printed or rolled onto the open layer. A support layer may be added the liquid SAP may be activated and the resultant lightly compressed. Then dry and roll the finished tape.

The resulting structure of the tape in cross section will be as shown in FIG. 3, although some of the SAP will have migrated into the open layer as in FIG. 2. The adhesive may be of many types known in the art, but water based acrylic latices (acrylic latex) and polyvinyl alcohol or blends thereof are preferred.

Using conventional slitting techniques the finished tapes may be converted into narrow widths, typically of 4 to 1600 mm. For example, a duplex rewind center surface type slitter can be sued, or a duplex rewind center minimum gap slitter can be used. Choice of slitting blades will depend on the support layer, open layer and reinforcing layer (if any). Score type blades, rotary shear and razor in groove or razor in air may be used. All of the above choices are well known to those skilled in the art.

In addition any of the above tapes may be converted into either narrow width pads or marrow width traverse spools for extended length payoff.

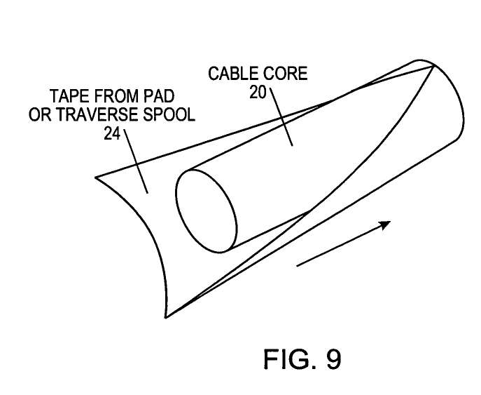

FIGS. 8 and 9 illustrate typical tape application to cable cores 20. FIG. 8 shows a helical wrapping and FIG. 9 a longitudinal wrapping. The point of application of the inventive tape can occur at several points in the construction of a finished cable. The inventive tape may be added directly before and under the extrusion or wrapped of insulation, during core assembly, at wire serving (under or over the serving), at armoring, at sheathing or directly under the jacketing extrusion. The sheathing may be of metal or other longitudinally corrugated or smooth sheaths.

In an assembled cable the inventive tape may be used as a buffer layer in optical fiber cables with the smooth surface of the open layer directly in contact with the optical fiber. As mentioned above, the inventive cable will prevent the SAP material from reaching the cable core. The smooth surface of the open layer compression on the cable can be tailored to the cable requirements allowing the open layer to grip the cable core and create a mechanical bridge between the cable core and the outer cable strength elements. These outer strength elements are designed to allow the normal handling and pulling on the cable. In practice the SAP and open layers may be tailored by trial and error methods before an optimum selection of materials, amounts and processing steps are determined. The resultant cable will be lighter than grease or gel filled cables and will be more easily spliced and terminated.

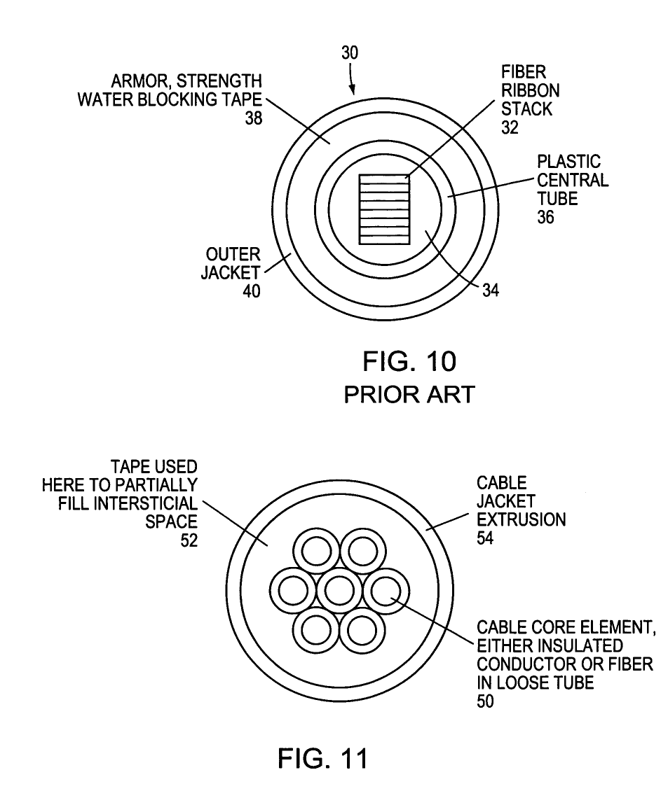

FIG. 10 shows an optical fiber cable with an optical ribbon stack 32. In this embodiment the inventive tape is wound around the optical stack 34. As mentioned above, the inventive tape will conform to and compress the optical stack presenting a smooth surface securing the stack without damaging it. In this embodiment, there is a plastic shield 36 surrounding the taped inner core. The plastic, in turn, is surrounded with an armor strength element 38 and finally an outer jacket 40.

The compressive open layer in FIG. 10, as mentioned above, compresses and conforms to the optical cable. Such conforming fills the interstices in the cable and provides an added benefit of impeding any inrush of water due to failure of the outer layers. This impedance of the water in rush provides time that allows the SAP to react to limit any farther encroachment of the water. In low voltage cables carrying electrical power the inventive tape would be formed as an electrically non-conductive element.

FIG. 11 illustrates a low voltage power cable where the inventive tape is formed to fill the intersticial spaces. Here an inner core is shown as insulated conductors 50. The inventive tape 52 surrounds the inner core filling the available space. Here again the compressive open layer compresses and conforms to the uneven perimeter of the inner core. An outer jacket 54 surrounds the entire cable assembly.

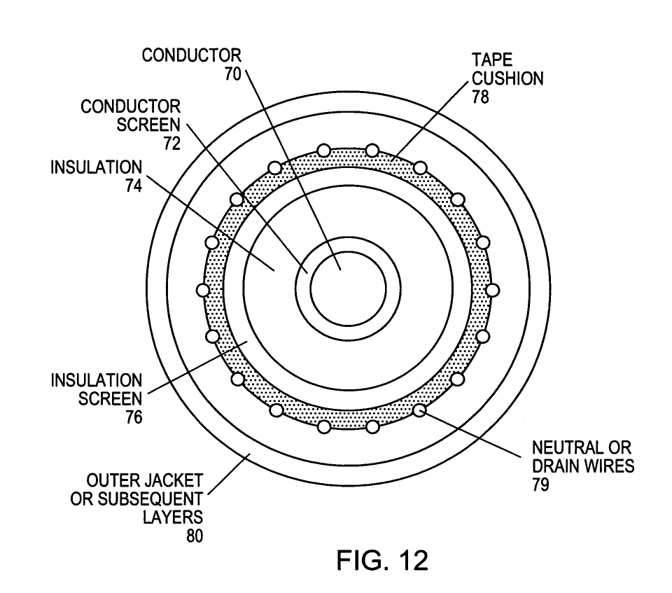

Another use the inventive tape, where voltage may be of medium of high voltage (hundreds/thousands of volts), is shown in FIG. 12. Here the tape layer 78 provides a mechanical buffer screening the cable core. For such cables, the inventive tape open layer provides some relief from thermo mechanical expansion and contraction under cable load cycling. The tape is semi-conductive to provide a leakage current path along with drain wires 79 for the cable core leakage currents found in normal operating conditions. The open layer 78 provides thermal endurance and support for the outer layers found in some cables, for example, outer layers of metal wire screens, corrugated metal sheaths and helical metal armor. The inventive semi-conductive tapes can be used in medium and high voltage cables when several additional outer mechanical strength layers are used. In FIG. 12 an inner conductive core 70 is surrounded by a conductor screen 72, an insulator 74, and insulator screen 74, the semi-conductive inventive tape 78, drain wires 79 and an outer jacket 80. There may be addition layers, not shown.

In typical applications semi-conductive tape exhibit volume resistivities that range from about 0.1 to 5 meg ohm centimeter. Non conductive tapes exhibit volume resistivities greater than 10 meg ohms centimeter. These are representative values and other values may be used to advantage is other applications.

FIG. 12 is a cross section of a power cable using the inventive tape.

It should be understood that above-described embodiments are being presented herein as examples and that many variations and alternatives thereof are possible. Accordingly, the present invention should be viewed broadly as being defined only as set forth in the hereinafter appended claims.

1. A tape comprising:
an open cell layer,
a super absorbent layer in interfering contact with the open cell layer, wherein the super absorbent layer penetrates into the open cell layer, and wherein the super absorbent layer penetrates farther into the open cell layer when the super absorbent layer swells.

2. The tape of claim 1 further comprising:
a support layer having two sides with the first side in interfering contact with the super absorbent layer.

3 The tape of claim 2 further comprising:
a second open cell layer,
a second super absorbent layer in interfering contact with the second open cell layer, wherein the second super absorbent layer penetrates into the open cell layer, wherein the super absorbent layer penetrates farther into the second open cell layer when the super absorbent layer swells, and wherein the second super absorbent layer is in interfering contact with the second side of the support layer.

4. The tape of claim 1 wherein the super absorbent layer on the open cell layer comprises a material form selected from the group consisting of a powder, a liquid and a fiber.

5. The tape of claim 4 wherein the super absorbent layer material is selected from the group consisting of materials that swell when exposed to water.

6. The tape of claim 1 wherein the super absorbent layer material swells at least by a factor of twenty.

7. The tape of claim 1 further comprising an adhesive placed between the open cell layer and the super absorbent layer.

8. The tape of claim 1 wherein the open cell layer is of a material form selected from the group consisting of a textile and a synthetic fiber base.

9. The tape of claim 1 wherein the open cell layer is a polymer.

10. An optical fiber cable comprising:
an inner core having optical fibers,
an elongated open cell layer with a first side and a second side,
an elongated super absorbent layer in interfering contact with the elongated open cell layer first side thereby forming a composite tape structure, wherein the elongated super absorbent layer penetrates into the open cell layer, wherein the super absorbent layer penetrates farther into the open cell layer when the super absorbent layer swells, wherein the composite tape structure is arranged surrounding the inner core.

11. The cable of claim 10 wherein the composite tape surrounds the inner core with the second side of the composite tape facing the inner core.

12. The cable of claim 10 wherein the composite tape is an electrical insulator.

13. The tape of claim 10 wherein the super absorbent layer on the open cell layer comprises a material form selected from the group consisting of a powder, a liquid and a fiber.

14. The tape of claim 10 wherein the super absorbent layer material is selected from the group consisting of materials that swell when exposed to water.

15. The tape of claim 10 wherein the super absorbent layer material swells at least by a factor of twenty.

16. The tape of claim 10 further comprising an adhesive placed between the open cell layer and the super absorbent layer.

17. The tape of claim 10 wherein the open cell layer is a material form selected from the group consisting of a textile and a synthetic fiber base.

18. The tape of claim 10 wherein the open cell layer is a polymer.

19. A voltage carrying cable comprising:
an inner core having electrical conductors,
an elongated open cell layer with a first side and a second side,
an elongated super absorbent layer in interfering contact with the elongated open cell layer first side thereby forming a composite tape structure, wherein the elongated super absorbent layer penetrates into the open cell layer, wherein the super absorbent layer penetrates farther into the open cell layer when the super absorbent layer swells, wherein the composite tape structure is arranged surrounding the inner core.

20. The cable of claim 19 wherein the composite tape surrounds the inner core with the second side of the composite tape facing the inner core.

21. The cable of claim 19 wherein the composite tape is an electrical semi-conductor.

22. The cable of claim 19 wherein the composite tape is an electrical insulator.

23. The tape of claim 19 wherein the super absorbent layer on the open cell layer comprises a material form selected from the group consisting of a powder, a liquid and a fiber.

24. The tape of claim 19 wherein the super absorbent layer material is selected from the group consisting of materials that swell when exposed to water.

25. The tape of claim 24 wherein the super absorbent layer material swells at least by a factor of twenty.

26. The tape of claim 19 further comprising an adhesive placed between the open cell layer and the super absorbent layer.

27. The tape of claim 19 wherein the open cell layer is of a material form selected from the group consisting of a textile and a synthetic fiber base.

28. The tape of claim 19 wherein the open cell layer is a polymer.

29. A process for making a tape comprising the steps of:
forming an open cell layer,
placing a super absorbent layer in interfering contact with the open cell layer, wherein the super absorbent layer penetrates into the open cell layer, and wherein the super absorbent layer penetrates farther into the open cell layer when the super absorbent layer swells.

30. The process of claim 29 further comprising the steps of:
providing a support layer having two sides with the first side in interfering contact with the super absorbent layer.

31 The process of claim 30 further comprising the steps of:
providing a second open cell layer,
placing a second super absorbent layer in interfering contact with the second open cell layer, wherein the second super absorbent layer penetrates into the open cell layer, wherein the super absorbent layer penetrates farther into the second open cell layer when the super absorbent layer swells, and wherein the second super absorbent layer is in interfering contact with the second side of the support layer.
